(19) United States
(12) Patent Application Publication
(10) Pub. No.: US 2026/0253930 A1
(43) Pub. Date: Aug. 27, 2026

(54) FUEL CELL APPARATUS INCLUDING FILTER MODULE

(71) Applicants: HYUNDAI MOTOR COMPANY, Seoul (KR); Kia Corporation, Seoul (KR)

(72) Inventors: Dong Nyeok PARK, Hwaseong-si (KR); In Tae PARK, Hwaseong-si (KR); Hae Lee LEE, Hwaseong-si (KR)

(21) Appl. No.: 19/541,859

(22) Filed: Feb. 17, 2026

(30) Foreign Application Priority Data
Feb. 24, 2025 (KR) 10-2025-0023817
Sep. 26, 2025 (KR) 10-2025-0140131

(51) Int. Cl. H01M 8/0662; B01D 39/10; B01D 46/00; B01D 46/10; H01M 8/04014; H01M 8/04119

(52) U.S. Cl. CPC H01M 8/0687; B01D 39/10; B01D 46/0005; B01D 46/10; H01M 8/04014; H01M 8/04126; B01D 2265/06

(57) ABSTRACT

Disclosed is a filter module that may include, for example, a filter body. A first opening portion and a second opening portion may be formed in the filter body. The filter module may further include: a mesh frame formed over the first opening portion and protruding from a surface of the filter body; and a mesh installed on and affixed to the mesh frame and configured to filter out foreign substances in a fluid passing through the filter body.

### CROSS-REFERENCE TO RELATED APPLICATIONS

This application claims priority to and the benefit of Korean Patent Application No. 10-2025-0023817, filed in the Korean Intellectual Property Office on Feb. 24, 2025, and Korean Patent Application No. 10-2025-0140131, filed in the Korean Intellectual Property Office on Sep. 26, 2025, the entire contents of which are incorporated herein by reference.

### TECHNICAL FIELD

The present disclosure relates to fuel cells and more particularly to fuel cell filter modules.

### BACKGROUND

Air may be supplied to a stack in a fuel cell system. The air may, for example, sequentially pass through a supply path around various components of the fuel cell system, such as an air compressor (ACP), a heat exchanger (e.g., air cooler (ACL)), a humidifier (e.g., air humidifier (AHF)), and an air cut-off valve (ACV). At an inlet of the stack, oxygen may be supplied to a membrane electrode assembly (MEA) through an air-side bipolar plate (BP). In this case, a flow path structure or shape of the bipolar plate may prevent, to some extent, foreign substances (e.g., dust particles), which may be introduced from components of an air processing system (APS), from being introduced into the stack.

At least in some implementations, the shape or structural design of the bipolar plate may be relied on to prevent the introduction of foreign substances without having a separate filter structure, which may cause difficulty in completely blocking out foreign substances. In particular, in case that fine foreign substances accumulated along an air supply flow path are introduced into the stack along a flow path on the bipolar plate, problems may arise where performance of the membrane electrode assembly may deteriorate and the lifespan of the stack may decrease.

In addition, under structural constraints of the system in which the existing component configuration needs to remain intact, it may be necessary to consider interference between components or ensure a space for introducing a new filtering means.

Therefore, there is a need for an air purification structure capable of effectively blocking out foreign substances that may occur in an air supply line, without having to change the structures of the existing configurations, and improving system reliability.

As technology develops to increase an output density of a fuel cell, a cell pitch may decrease, and the thicknesses of a flow path and a gas diffusion layer (GDL) may also decrease. In particular, as a height of a flow path on a cathode-side bipolar plate decreases, the risk of incurring blockage in the flow path, a pressure loss, or deterioration in performance caused by fine foreign substances contained in the air flow path may be further increased. For example, a cleanliness level of 0.1 mm or less may be required for an air inlet path in some implementations.

The matters described in this Background section are only for enhancement of understanding of the background of the disclosure, and should not be taken as acknowledgement that they correspond to prior art already known to those skilled in the art.

### SUMMARY

The present disclosure has been made in an effort to provide a filter module (also referred to as filter assembly) applicable to various fuel cell electric vehicles including passenger vehicles and commercial vehicles, thereby effectively filtering out foreign substances introduced into a fuel cell stack along an air supply path and improving durability of the fuel cell stack.

The present disclosure has also been made in an effort to provide a filter module capable of stably maintaining the generation of electric current in a fuel cell by supplying more uniformly humidified air to a stack while preventing the generation of local droplets in air, which has passed through a humidifier, by means of a mesh part having a plurality of fine pores.

The present disclosure has also been made in an effort to apply a filter module to alleviate a foreign substance management criterion, simplify a manufacturing process condition for related components, and ensure price competitiveness of a system.

According to one or more example embodiments of the present disclosure, a filter assembly may include a filter body. A first opening portion and a second opening portion may be formed in the filter body. The filter assembly may further include: a mesh frame formed over the first opening portion and protruding from a surface of the filter body; and a mesh installed on and affixed to the mesh frame and configured to filter out foreign substances in a fluid passing through the filter body.

The mesh frame may protrude in an intake direction of the first opening portion.

The mesh frame may include a plurality of ribs that start at positions, which are located at predetermined intervals around a rim of the first opening portion, and meet on a centerline, of the first opening portion, that extends in an intake direction of the first opening portion.

The mesh may include a wire mesh having a plurality of grooves.

The wire mesh may be composed of a metallic material.

A plurality of holes may be formed on a flat surface of the filter body. The plurality of holes may open in a direction orthogonal to the flat surface of the filter body.

The filter assembly may further include: a plurality of bushings each coupled, by fitting, to a corresponding hole of the plurality of holes. For each bushing of the plurality of bushings, a groove may be formed in a circumferential direction in an outer peripheral surface of the bushing.

A first seating groove may be formed, in the filter body, to surround the first opening portion. A second seating groove may be formed, in the filter body, to surround the second opening portion.

The filter body may include: a plurality of first outer walls connecting the first opening portion and the second opening portion and formed in a stepped region, which excludes the first opening portion and the second opening portion and is hollowed in a direction orthogonal to a flat surface of the filter body; and a second outer wall formed to traverse the plurality of first outer walls.

The stepped region may be formed to have a thickness between 20% and 40% of a thickness of the filter body.

According to one or more example embodiments of the present disclosure, a fuel cell apparatus may include: an air compressor configured to compress and supply air; a heat exchanger positioned at a downstream side of the air compressor and configured to adjust a temperature of the air; a humidifier positioned at a downstream side of the heat exchanger and configured to humidify the air; a cut-off valve positioned at a downstream side of the humidifier and configured to control a supply amount of the air; a filter assembly positioned at a downstream side of the cut-off valve and configured to prevent foreign substances, in the air supplied from the cut-off valve, from entering a fuel cell stack of the fuel cell apparatus; and the fuel cell stack configured to generate electricity based on an electrochemical reaction between oxygen and hydrogen in the air.

The filter assembly may include a mesh frame configured to affix a wire mesh. The wire mesh may be configured to filter out the foreign substances.

The mesh frame may protrude toward the fuel cell stack.

The filter assembly may be disposed and coupled between the cut-off valve and an air duct of the fuel cell stack.

According to one or more example embodiments of the present disclosure, a filter assembly for a fuel cell apparatus may include a filter body including one or more walls and one or more fastener holes. The one or more walls may form a first opening and a second opening. The filter body may be configured to, after being attached to the fuel cell apparatus via the fastener holes, allow an intake air to pass, via the first opening, to a fuel cell stack of the fuel cell apparatus, and allow a discharge liquid to pass via the second opening. The filter assembly may further include a mesh affixed to the filter body. The mesh may be disposed over the first opening of the filter body and protruding, from the filter body, in a flow direction of the intake air.

The filter assembly may further include: one or more bushings inserted into the one or more fastener holes.

The filter body may be configured to attach to a cut-off valve of the fuel cell apparatus.

Each fastener hole, of the one or more fastener holes, may be a through hole configured to receive a fastener.

The fastener may be a bolt.

According to the present disclosure, the filter module may be applied to air supply paths of various fuel cell electric vehicles including passenger vehicles and commercial vehicles, thereby filtering out foreign substances in the air introduced into the stack and improving the durability of the stack.

The mesh part having the plurality of fine pores may prevent the generation of local droplets present in the humidified air having passed through the humidifier and more stably maintain the generation of electric current in the fuel cell by supplying the humidified air to the stack.

The filter module may be applied to an air supply part, such that the foreign substance management criterion related to relevant components, such as valves, pipes, and ducts in the fuel cell system, may be alleviated, thereby simplifying the manufacturing process condition for the corresponding components and ensuring price competitiveness.

### BRIEF DESCRIPTION OF THE DRAWINGS

FIG. 1 is a block diagram of an example fuel cell apparatus.

FIG. 2 is a perspective view of an example filter assembly.

FIG. 3 is a perspective view of an example bushing.

FIG. 4 is a cross-sectional view of an example filter assembly.

FIG. 5 is a front view of an example filter assembly in a mounted position.

### DETAILED DESCRIPTION

Hereinafter, a fuel cell apparatus and a filter module according to one or more example embodiments will be described with reference to the drawings.

Unless otherwise defined, the terms used herein, including technical or scientific terms, may have meanings generally understood by those skilled in the art to which the present disclosure belongs.

The expressions such as “comprise,” “may comprise,” “include,” “may include,” “have,” “may have,” etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip,” “second chip,” respectively.

The expression “based” on as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to,” “with the ability to,” “modified to,” “made to,” “to be able to,” etc. This expression is not limited to the meaning of “specially designed in hardware to.” For example, a processor configured to perform a specific operation may refer to a generic purpose processor capable of performing the specific operation by executing software, or to a special purpose computer structured through programming to perform the specific operation.

For purposes of the present application and the claims, using the example phrase “at least one of: A; B; or C” or “at least one of A, B, or C,” the phrase means “at least one A, or at least one B, or at least one C, or any combination of at least one A, at least one B, and at least one C. Further, example phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

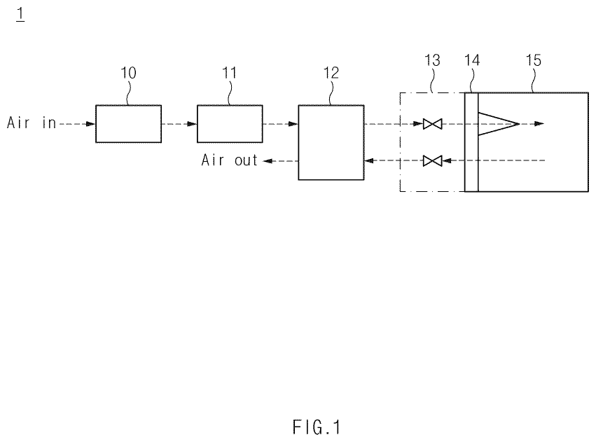

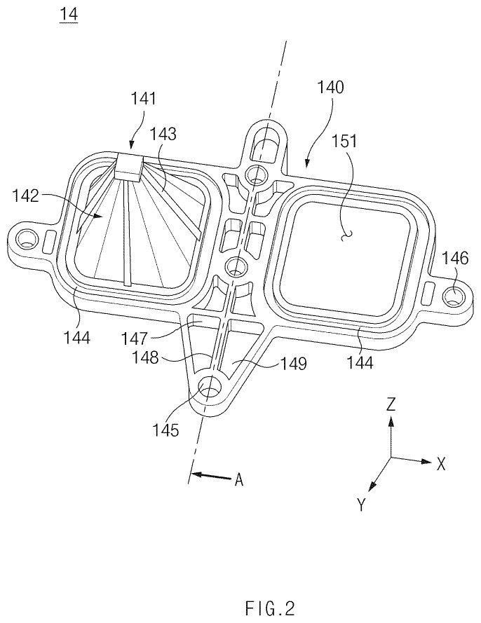

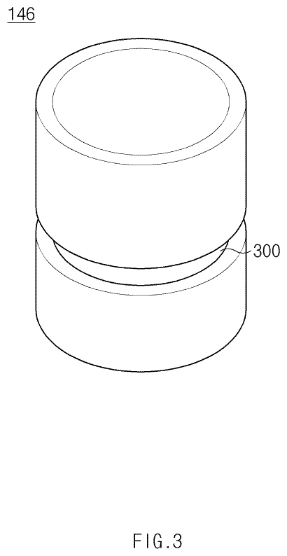

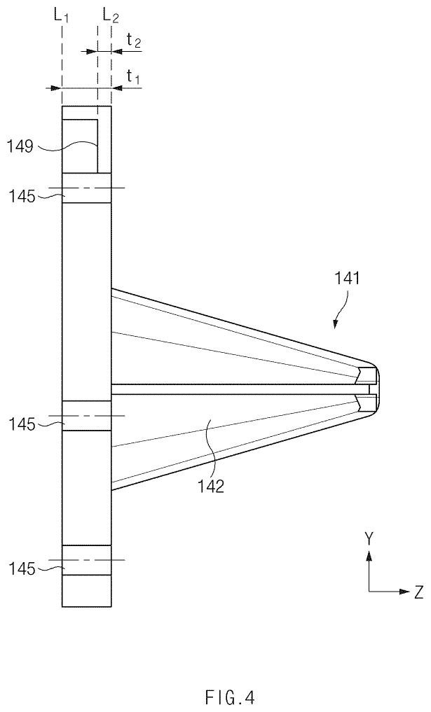

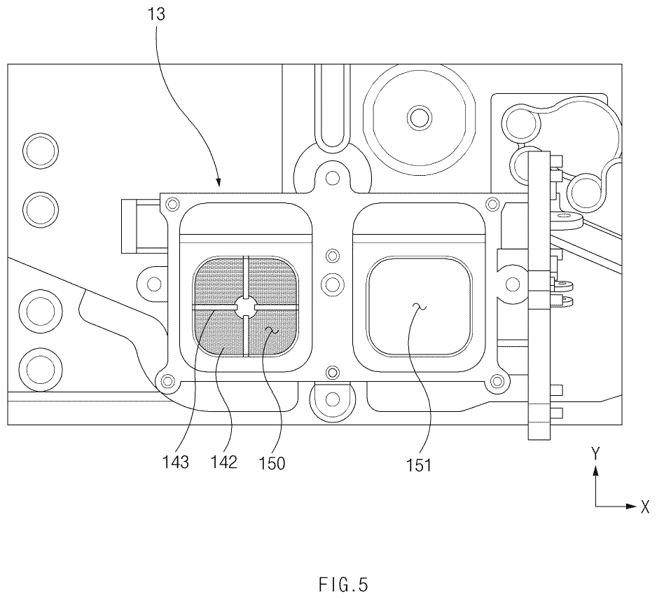

FIG. 1 is a block diagram of an example fuel cell apparatus, and FIG. 2 is a perspective view of the filter assembly. In addition, FIG. 3 is a perspective view of an example bushing. FIG. 4 is a cross-sectional view of an example filter assembly. Specifically, the cross-sectional view of FIG. 4 is taken along line A as shown in FIG. 2. In addition, FIG. 5 is a front view of the example filter assembly in a mounted position.

With reference to FIGS. 1 to 5, a fuel cell apparatus 1 may include some or all of an air compressor 10, a heat exchanger 11, a humidifier 12, a cut-off valve 13, a filter assembly 14, and a stack (also referred to as fuel cell stack) 15.

For reference, the fuel cell apparatus 1 may be applied to various mobility vehicles, such as vehicles (e.g., construction machines or passenger vehicles), ships, or aircraft, to which the fuel cell stack 15 may be applied. However, the present disclosure is not restricted or limited by the types and properties of objects to which the fuel cell apparatus 1 is applied as shown in the example embodiment(s).

Inflow gas (air), which is supplied to an inflow gas supply port of the humidifier 12 via the air compressor 10 and the heat exchanger 11, may be humidified by moist air while passing through a humidification membrane (e.g., a hollow fiber membrane) (not illustrated) provided in the form of a tube and disposed in the humidifier 12. Then, the humidified inflow gas may be supplied to the stack 15 via the inflow gas discharge port.

The cut-off valve 13 may be positioned (e.g., disposed) at a downstream side (e.g., exhaust, outlet, etc.) of the humidifier 12 and allows or cuts off a supply of air (e.g., control the amount of air supplied). The cut-off valve 13 is disposed in a path through which the air is supplied from the humidifier 12 to the stack 15 and discharged from the stack 15.

The stack 15 may refer to a kind of power generation device that generates electrical energy through a chemical reaction (e.g., electrochemical reaction) of fuel (e.g., oxygen and hydrogen in the air supplied by the air compressor 10). The stack 15 may be configured by stacking several tens or hundreds of fuel cells (unit cells) (not illustrated) in series. In this case, the fuel cell may have various structures capable of generating electricity through a redox reaction between fuel and an oxidant.

For example, the fuel cell may include: a membrane electrode assembly (not illustrated) having catalyst electrode layers in which electrochemical reactions (e.g., between oxygen and hydrogen) occur and which are attached to two opposite ends of an electrolyte membrane through which hydrogen ions move; a gas diffusion layer (not illustrated) configured to uniformly distribute reactant gases and transfer generated electrical energy; a gasket (not illustrated) and a fastener (not illustrated) configured to maintain leakproof sealability for the reactant gases and a coolant and maintain an appropriate fastening pressure; and a separator (bipolar plate) (not illustrated) configured to move the reactant gases and the coolant.

The filter assembly (also referred to as filter module) 14 may be positioned (e.g., disposed) at a downstream side (e.g., exhaust, outlet, etc.) of the cut-off valve 13. The filter assembly 14 may prevent foreign substances (e.g., contaminants, foreign particles, dust, etc.) in the air supplied from the cut-off valve 13 from being introduced into (e.g., from entering) the stack 15.

The filter assembly 14 may be applied to an air supply path of the fuel cell apparatus 1 regardless of the type of vehicle such as a passenger vehicle and a commercial vehicle. The filter assembly 14 may effectively filter out foreign substances in the air introduced into (e.g., entering) the stack 15, thereby improving the durability of the stack 15.

The filter assembly 14 may anticipatively block out foreign substances before the foreign substances (e.g., contaminants) are introduced into (e.g., entering) the stack 15, thereby alleviating a foreign substance management criterion for constituent components of the fuel cell apparatus 1 and reducing process condition requirements or required precision levels for the respective components.

The filter assembly 14 may include a filter body 140, a fixing part 141, and a mesh part 142.

The filter body (also referred to as filter frame) 140 may include a plurality of holes 145. The plurality of holes 145 of the filter body 140 are formed to physically couple the filter assembly 14 between the cut-off valve 13 and the stack 15.

The filter body 140 may include a first opening portion 150 and a second opening portion 151.

The first opening portion 150 may be a path through which a fluid on the filter assembly 14, which is configured to transmit the fluid to the stack 15 via the cut-off valve 13, is introduced.

The second opening portion 151 may be a path through which the fluid on the filter assembly 14 is discharged when the air supplied to the stack 15 moves back to the humidifier 12 via the filter assembly 14.

The filter body 140 includes first outer wall(s) 147 and a second outer wall 148.

The first outer wall(s) 147 and the second outer wall 148 are formed on a stepped region 149 formed on one side surface of the filter body 140.

The stepped (e.g., hollowed) region 149 may be formed in a region, which excludes the first opening portion 150, the second opening portion 151, and the plurality of holes 145, and stepped (e.g., hollowed) inward (in a Z-axis direction) based on a thickness direction of the filter body 140 (e.g., in a direction orthogonal to a flat surface of the filter body 140).

The first outer wall(s) 147 may be formed on the stepped region 149 and connects the first opening portion 150 and the second opening portion 151. For example, the first outer wall(s) 147 may extend in an X-axis direction illustrated in FIG. 2. The first outer wall(s) 147 may be formed on the stepped region 149 and have a thickness (e.g., in the Y-axis direction) corresponding to a thickness (e.g., in the Z-axis direction) of the filter body 140.

The first outer wall 147 may be provided as a plurality of first outer walls 147. The plurality of first outer walls 147 may be formed to connect the first opening portion 150 and the second opening portion 151.

The second outer wall 148 may be formed to traverse the plurality of first outer walls 147. For example, the second outer wall 148 may extend in a Y-axis direction illustrated in FIG. 2. The second outer wall 148 may be formed to have a thickness corresponding to the thickness of the first outer wall 147.

The structure formed by the stepped region 149, the first outer wall(s) 147, and the second outer wall 148 may minimize contraction and deformation of the filter body 140. This is because the amount of contraction during cooling is large, and deformation and warping are more likely to occur as the thickness of the filter body 140 increases.

The filter body 140 may include seating grooves 144.

The seating grooves 144 may be formed to surround the first opening portion 150 and the second opening portion 151.

Although not illustrated in FIG. 2, gaskets (not illustrated) may be disposed in the seating grooves 144. When the filter assembly 14 is fixed between the cut-off valve 13 and the stack 15, the gaskets may be disposed between the cut-off valve 13 and the stack 15 and maintain sealability between the filter assembly 14 and the cut-off valve 13.

The fixing part (also referred to as mesh frame) 141 may be formed on (e.g., over) the first opening portion 150 of the filter body 140. The fixing part 141 may protrude from (e.g., with respect to) a surface of the filter body 140.

The fixing part 141 may be integrally formed on (e.g., over) the first opening portion 150.

The fixing part 141 may include a plurality of ribs 143. The plurality of ribs 143 may be formed such that the plurality of ribs 143 start at positions, which are spaced apart from (e.g., located around) a rim of the first opening portion 150 at a predetermined distance (e.g., at predetermined intervals), and meet together on (e.g., along) a centerline of the first opening portion 150 (e.g., a line extending orthogonally from a center of the first opening portion 150) that extends in a direction in which the first opening portion 150 is opened (the Z-axis direction illustrated in FIG. 2). For example, the fixing part 141 (e.g., the plurality of ribs 143) may protrude in an intake direction (e.g., a flow direction of an intake air through the first opening portion 150).

The mesh part (also referred to as mesh) 142 may be configured as a wire mesh having a plurality of fine grooves (e.g., a plurality of grooves having a mesh size of a predetermined size or less or having a mesh count of at least a predetermined number). In this case, the wire mesh may be made (e.g., composed) of a metallic material. For example, the wire mesh may be formed by using a metallic material, such as stainless steel (SUS), nickel (Ni), or titanium (Ti), for example. However, the material of the wire mesh is not limited thereto. The wire mesh may be made of various materials, such as synthetic resin, ceramic, and composite materials, in consideration of usage environment, corrosion resistance, strength, manufacturing costs, and the like.

For example, the wire mesh, which constitutes the mesh part 142, may be designed to ensure an aperture ratio of 50% or more. Therefore, a wire diameter of the wire mesh may be 0.03 to 0.05 mm, for example. In addition, a size of the fine hole formed in the wire mesh may be 0.075 to 0.085 mm, for example.

The mesh part 142 may prevent the formation of local droplets in humidified air having passed through the humidifier 12 and supply uniformly humidified air to the stack 15, thereby ensuring the smooth generation of electric current and the performance stability of the fuel cell.

The mesh part 142 may be disposed adjacent to the first opening portion 150 on the filter body 140, such that the mesh part 142 may filter out foreign substances (e.g., contaminants) in the fluids passing through an inflow path of the stack 15. For example, the mesh part 142 may be installed on (e.g., over) and/or fixed (e.g., affixed) to the fixing part 141.

The filter assembly 14 may include bushings 146. The bushings 146 may be coupled to the plurality of holes (also referred to as fastening holes) 145 by fitting. Each of the plurality of holes may be a through hole configured to receive a fastener (e.g., bolt).

A groove 300 is formed in a circumferential direction in an outer peripheral surface of the bushing 146. A cross-section of the groove 300 may have a ‘V’-shaped cross-sectional shape. However, the cross-sectional shape of the groove 300 is not limited thereto. The groove 300 serves to prevent the bushing 146 from being withdrawn from the hole 145 when the bushing 146 is coupled to the hole 145 by fitting.

The filter assembly 14 may be fastened between the cut-off valve 13 and the stack 15 by using bolts penetratively coupled to the bushing 146. The fastening structure of the filter assembly 14 allows the filter assembly 14 to be replaced without disassembling the cut-off valve 13 during a maintenance or replacement process.

A thickness t2 of the stepped region 149 may be 20% to 40% of a thickness t1 of the filter body 140. Specifically, the filter body 140 has the thickness t1 from a surface L1, which is joined to the cut-off valve 13, to a surface L2 that is joined to an air duct at a side of the stack 15.

The present disclosure provides a filter module including: a filter body formed with a first opening portion and a second opening portion; a fixing part protruding from one surface of the filter body; and a mesh part installed on and fixed to the fixing part and configured to filter out foreign substances in a fluid passing through the filter body, in which the fixing part is formed on the first opening portion.

The fixing part may protrude in a direction in which the first opening portion is opened.

The fixing part may include a plurality of ribs that start at positions, which are spaced apart from a rim of the first opening portion at a predetermined distance, and meet together on a centerline of the first opening portion that extends in a direction in which the first opening portion is opened.

The mesh part may be configured as a wire mesh having a plurality of fine grooves.

The wire mesh may be made of a metallic material.

The filter body may be formed with a plurality of holes opened in a thickness direction.

The filter module may further include: bushings coupled to the plurality of holes by fitting, in which a groove is formed in a circumferential direction in an outer peripheral surface of the bushing.

The filter body may be formed with seating grooves formed to surround the first opening portion and the second opening portion.

The filter body may include: a plurality of first outer walls formed in a region, which excludes the first opening portion and the second opening portion based on a thickness direction, formed on an inwardly stepped region, and configured to connect the first opening portion and the second opening portion; and a second outer wall formed to traverse the plurality of first outer walls.

The stepped region may be formed to have a thickness of 20 to 40% of a thickness of the filter body.

In order to achieve the above-mentioned object, another aspect of the present disclosure provides a fuel cell apparatus including: an air compressor configured to compress and supply air; a heat exchanger positioned at a downstream side of the air compressor and configured to adjust a temperature of the air; a humidifier positioned at a downstream side of the heat exchanger and configured to humidify the air; a cut-off valve positioned at a downstream side of the humidifier and configured to perform control to allow or cut off a supply of air; a filter module positioned at a downstream side of the cut-off valve and disposed to prevent foreign substances in the air supplied from the cut-off valve from being introduced into a stack; and the stack configured to generate electricity in accordance with an electrochemical reaction between oxygen and hydrogen.

The filter module may include a fixing part configured to fix a wire mesh configured to filter out foreign substances.

The fixing part may protrude toward the stack.

The filter module may be disposed and coupled between the cut-off valve and an air duct of the stack.

The present disclosure has been described with reference to the limited embodiments and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A filter assembly comprising:
a filter body, wherein a first opening portion and a second opening portion are formed in the filter body;
a mesh frame formed over the first opening portion and protruding from a surface of the filter body; and
a mesh installed on and affixed to the mesh frame and configured to filter out foreign substances in a fluid passing through the filter body.

2. The filter assembly of claim 1, wherein the mesh frame protrudes in an intake direction of the first opening portion.

3. The filter assembly of claim 1, wherein the mesh frame comprises a plurality of ribs that start at positions, which are located at predetermined intervals around a rim of the first opening portion, and meet on a centerline, of the first opening portion, that extends in an intake direction of the first opening portion.

4. The filter assembly of claim 1, wherein the mesh comprises a wire mesh having a plurality of grooves.

5. The filter assembly of claim 4, wherein the wire mesh is composed of a metallic material.

6. The filter assembly of claim 1, wherein a plurality of holes are formed on a flat surface of the filter body, wherein the plurality of holes open in a direction orthogonal to the flat surface of the filter body.

7. The filter assembly of claim 6, further comprising:
a plurality of bushings each coupled, by fitting, to a corresponding hole of the plurality of holes,
wherein, for each bushing of the plurality of bushings, a groove is formed in a circumferential direction in an outer peripheral surface of the bushing.

8. The filter assembly of claim 1, wherein a first seating groove is formed, in the filter body, to surround the first opening portion, and wherein a second seating groove is formed, in the filter body, to surround the second opening portion.

9. The filter assembly of claim 1, wherein the filter body comprises:
a plurality of first outer walls connecting the first opening portion and the second opening portion and formed in a stepped region, which excludes the first opening portion and the second opening portion and is hollowed in a direction orthogonal to a flat surface of the filter body; and
a second outer wall formed to traverse the plurality of first outer walls.

10. The filter assembly of claim 9, wherein the stepped region is formed to have a thickness between 20% and 40% of a thickness of the filter body.

11. A fuel cell apparatus comprising:
an air compressor configured to compress and supply air;
a heat exchanger positioned at a downstream side of the air compressor and configured to adjust a temperature of the air;
a humidifier positioned at a downstream side of the heat exchanger and configured to humidify the air;
a cut-off valve positioned at a downstream side of the humidifier and configured to control a supply amount of the air;
a filter assembly positioned at a downstream side of the cut-off valve and configured to prevent foreign substances, in the air supplied from the cut-off valve, from entering a fuel cell stack of the fuel cell apparatus; and
the fuel cell stack configured to generate electricity based on an electrochemical reaction between oxygen and hydrogen in the air.

12. The fuel cell apparatus of claim 11, wherein the filter assembly comprises a mesh frame configured to affix a wire mesh, and wherein the wire mesh is configured to filter out the foreign substances.

13. The fuel cell apparatus of claim 12, wherein the mesh frame protrudes toward the fuel cell stack.

14. The fuel cell apparatus of claim 12, wherein the filter assembly is disposed and coupled between the cut-off valve and an air duct of the fuel cell stack.

15. A filter assembly for a fuel cell apparatus, the filter assembly comprising:
a filter body comprising one or more walls and one or more fastener holes, wherein the one or more walls form a first opening and a second opening, and wherein the filter body is configured to, after being attached to the fuel cell apparatus via the fastener holes, allow an intake air to pass, via the first opening, to a fuel cell stack of the fuel cell apparatus, and allow a discharge liquid to pass via the second opening; and
a mesh affixed to the filter body, wherein the mesh is disposed over the first opening of the filter body and protruding, from the filter body, in a flow direction of the intake air.

16. The filter assembly of claim 15, further comprising:
one or more bushings inserted into the one or more fastener holes.

17. The filter assembly of claim 15, wherein the filter body is configured to attach to a cut-off valve of the fuel cell apparatus.

18. The filter assembly of claim 15, wherein each fastener hole, of the one or more fastener holes, is a through hole configured to receive a fastener.

19. The filter assembly of claim 18, wherein the fastener comprises a bolt.
